(19) United States
(12) Patent Application Publication
(10) Pub. No.: US 2024/0414085 A1
(43) Pub. Date: Dec. 12, 2024

(54) MULTI-STAGE TCAM MATCHING IN A NETWORK DEVICE

(71) Applicant: Marvell Asia Pte Ltd, Singapore (SG)

(72) Inventors: Chuanhai ZHOU, Cupertino, CA (US); Hong Yu CHOU, Saratoga, CA (US)

(21) Appl. No.: 18/737,719

(22) Filed: Jun. 7, 2024

Related U.S. Application Data
(60) Provisional application No. 63/471,746, filed on Jun. 7, 2023.

(51) Int. Cl. H04L 45/745; H04L 45/741

(52) U.S. Cl. CPC H04L 45/74591; H04L 45/741

(57) ABSTRACT

A network device generates one or more search keys to include information retrieved from one or more fields in a header of a packet being processed by the network device. The network device performs a first-stage search in a first-stage memory to map the one or more search keys to one or more search key identifiers. Respective ones of the one or more search key identifiers are shorter than corresponding ones of the one or more search keys. The network device also performs a second-stage search in a second-stage memory based on a combination of the one or more search key identifiers to identify an entry that matches the combination of the one or more search key identifiers. The entry indicates a processing rule matched by the packet. The network device performs, with respect to the packet, an action associated with the rule.

### CROSS REFERENCES TO RELATED APPLICATIONS

This application claims the benefit of U.S. Provisional Patent Application No. 63/471,746, entitled “Two Stages Key-based TCAM Lookup for Packet Identification,” filed on Jun. 7, 2023, the disclosure of which is hereby expressly incorporated herein by reference in its entirety.

### FIELD OF TECHNOLOGY

The present disclosure relates generally to network devices, and more particularly, to network devices performing processing of packets in vehicle networks with a relatively small, predefined number of network nodes.

### BACKGROUND

Network devices, such as network switches, routers, bridges, etc., process packets using information included in headers of the packet. For example, a network device performs searches based on layer-3 and/or layer-4 information extracted from a header of a packet to identify a processing rule matched by the packet, where the processing rule is associated with an action to be performed for processing the packet by the network device. Layer-3 information extracted from a header of a packet an internet protocol version four (IPv4) or an internet protocol version six (IPv6) source or destination address, for example. Layer-4 information includes a transmission control protocol (TCP) or a user datagram protocol (UDP) source or destination port number, for example. The action includes forwarding the packet to a particular port associated with the packet, assigning a transmission priority to the packet, etc.

Network devices often use ternary content addressable memories (TCAMs) to recognize known patterns within header information of packets being processed by the network device, such as combinations of layer-3 and/or layer-4 header field information within the header of the packet being processed by the network device. In a conventional network device, a TCAM stores search patterns corresponding to the processing rules in terms of specific values of particular header fields in headers of packets. For example, a typical TCAM stores a plurality of entries corresponding to different ones of the processing rules, each entry storing a combination of a particular IPv4/IPv6 source address, a particular IPv4/IPv6 destination address, a particular TCP/UDP source port number, and a particular TCP/UDP destination port number. The particular header fields identify devices in the network and/or applications executing on the devices in the network. Such network devices sometimes operate in networks having relatively small, predefined number of network nodes. For example, such network devices operate in automotive communication networks in vehicles where the number of network nodes is limited and is generally determined by the predefined number of devices, such as electronic control units (ECUs), central units, infotainment system components, other network switches or routers, etc., operating in the vehicle. In such networks, due to the large number of bits in the standard header fields, such as standard IPv4/IPv6 header address fields and the standard TCP/UDP port number fields, TCAMs used in the typical network devices are excessively large and expensive in terms of size, power consumption, cost, etc., given the relatively small, predefined number of devices and applications that are uniquely identified by the header fields.

### SUMMARY

In an embodiment, a method for processing packets by a network device operating in a network having network nodes includes: generating, by the network device, one or more search keys to include information retrieved from one or more fields in a header of a packet being processed by the network device; performing, the network device, a first-stage search in a first-stage memory to map the one or more search keys to one or more search key identifiers, respective ones of the one or more search key identifiers being shorter than corresponding ones of the one or more search keys; performing, by the network device, a second-stage search in a second-stage memory based on a combination of the one or more search key identifiers to identify an entry, in the second-stage memory, that matches the combination of the one or more search key identifiers, the entry indicating a rule, among a set of rules defined for processing packets by the network device, matched by the packet; and performing, with respect to the packet, an action associated with the rule.

In another embodiment a network device comprises a packet processor configured to process packets communicated over a network having network nodes. The packet processor includes a key generator configured to generate one or more search keys based on one or more header fields in a header of a packet being processed by the network device. The network device also comprises a search engine configured to determine an action to be performed with respect to the packet based on the one or more search keys. The search engine configured to: perform a first-stage search in a first-stage memory to map the one or more search keys to one or more search key identifiers, respective ones of the one or more search key identifiers being shorter than corresponding ones of the one or more search keys; perform a second-stage search in a second-stage memory based on a combination of the one or more search key identifiers to identify an entry that matches the combination of the one or more search key identifiers, the entry indicating a rule matched by the packet; identify an action to be performed with respect to the packet based on the rule matched by the packet; and provide an indication of the action to the packet processor to perform the action with respect to the packet, based on the rule.

### BRIEF DESCRIPTION OF THE DRAWINGS

FIG. 1 is a simplified block diagram of an example network device configured to perform multi-stage searches to identify processing rules matched by packet header information, according to an embodiment.

FIG. 2 is a block diagram of a search engine configured to perform multi-stage searches to identify processing rules in the network device of FIG. 1, according to an embodiment.

FIG. 3 is a diagram illustrating an example first-stage memory of the two-stage search memory of FIG. 2, according to an embodiment.

FIG. 4 is a diagram illustrating an example second-stage memory of the two-stage search memory of FIG. 2, according to an embodiment.

FIGS. 5A-B are diagrams illustrating an example set of rules and an example two-stage TCAM configured to implement precise matching to determine matching rules, according to an embodiment.

FIGS. 6A-B are diagrams illustrating an example set of rules and an example two-stage TCAM configured to implement binary maskable range matching with precise matching to determine matching rules, according to an embodiment.

FIGS. 7A-B are diagrams illustrating an example set of rules and an example two-stage TCAM configured to implement non-binary maskable range matching with precise matching to determine matching rules, according to an embodiment.

FIGS. 8A-B are diagrams illustrating an example set of rules and an example two-stage TCAM configured to implement binary maskable range matching with overlap precise matching to determine matching rules, according to an embodiment.

FIG. 9 is a block diagram of an example first-stage TCAM that supports multiple Layer 3 protocols, according to an embodiment.

FIG. 10 is a block diagram of an example first-stage TCAM that supports multiple Layer 4 protocols, according to an embodiment.

FIG. 11 is a flow diagram of an example method for processing packets by a network device operating in a network having a limited number of nodes, according to an embodiment.

### DETAILED DESCRIPTION

As discussed above, network devices utilize TCAMs to match various combinations of values of one or more header fields of packets being processed by the network device to stored search patterns in a TCAM to identify processing rules that apply to the packets based on the matched search patterns in the TCAM. For example, processing rules are defined for packets that match a combination of a particular IPV6/IPV4 source address, a particular IPv6/IPV4 destination address, a particular TCP/UDP source port number, and a particular TCP/UDP destination port number in a header of a packet. The processing rules indicate actions to be performed by the network device with respect to the packets, such as to which port the network device should transmit the packet, to which virtual local area network (VLAN) the network device should route the packet, which priority the network device should assign to the packet, etc. In a conventional network device, a TCAM stores search patterns corresponding to the processing rules using specific values of particular header fields in headers of packets. For example, a typical TCAM stores a plurality of entries corresponding to different ones of the processing rules, each entry storing a combination of a particular IPv4 or IPv6 (sometimes referred to herein as IPv4/IPv6) source address, a particular IPv4/IPv6 destination address, a particular TCP or UDP (sometimes referred to herein as TCP/UDP) source port number, and a particular TCP/UDP destination port number. Due to the large number of bits in the standard IPv4/IPv6 header address fields and the standard TCP/UDP port number fields, such typical TCAMs are expensive in terms of size, power consumption, cost, etc., particularly in systems that define a relatively large number of rules.

In embodiments described below, a network device is configured to operate in a communication network, such as an automotive communication network (e.g., Ethernet network) in a vehicle, having a relatively small, predefined number of network nodes. In such communication network, in at least some embodiments, the number of unique header field values, such as unique IPv6/IPV4 addresses and/or unique TCP/UDP port numbers, is limited by the number of network nodes and/or the number of applications executing on the network nodes and is relatively small due to the relatively small number of network nodes and applications. In such embodiments, the unique header field values used in the network can be represented by fewer number of bits as compared to the number of bits in the header fields of the packets processed by the network device. As just an example, in an embodiment, the number of unique IPv6/IPV4 addresses of devices in the network is significantly less than the number of all possible IPv6/IPV4 addresses in the standard IPV6/IPV4 address space. Accordingly, the IPv6/IPV4 addresses used in the network can be uniquely represented by a number of bits that is significantly less than the standard number of IPV6/IPv4 address bits. Similarly, in an embodiment, the number of unique TCP/UDP port numbers used by devices in the network is significantly less than the number of all possible TCP/UDP port numbers in the standard TCP/UDP port number space. Accordingly, the TCP/UDP port numbers used by the devices in the network can be uniquely represented by a number of bits that is significantly less than the standard number of TCP/UDP port number.

In an embodiment, the network device utilizes a multi-stage TCAM system in which processing rules are defined for matching by search key identifiers (IDs) that are shorter than search keys generated based on header fields, where the shorter search key IDs uniquely represent the limited number of header field values used in the network. In an embodiment, the multi-stage TCAM architecture includes a first-stage TCAM configured to match search keys generated based on header fields in headers of packets to map the search keys to the shorter search key IDs. The shorter search key IDs are then used to identify rules that match an entry in a second-stage TCAM that stores combinations of the shorter search key IDs that define the rules. As described in more detail below, in at least some embodiments, because the rules in the multi-stage TCAM architecture are defined in terms of the shorter search key IDs that uniquely represent all possible header field values used in the limited network, instead of being defined in terms of the longer header field values themselves, the multi-stage TCAM architecture offers significant saving in terms of size, power consumption, cost, etc., of the TCAM, without sacrificing any flexibility in uniquely defining the rules, as compared to systems in which the longer header field values are used for defining and matching the rules.

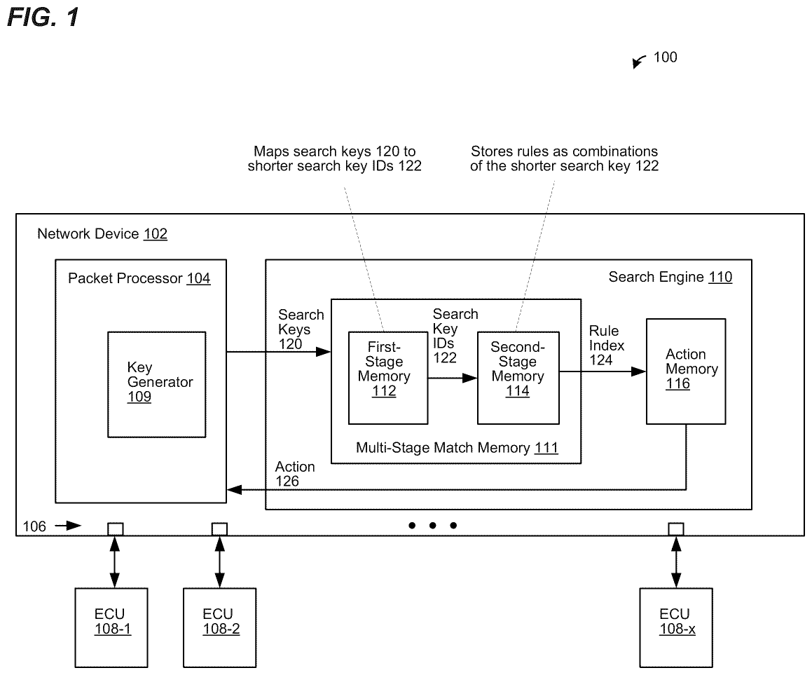

FIG. 1 is a simplified block diagram of an example network device 102 configured to operate in a network 100 with a limited number of nodes, according to an embodiment. In an embodiment, the network 100 is an automotive Ethernet network in a vehicle. In this embodiment, the number of nodes in the network is limited by the number of devices, such as electronic control units (ECUs), central units, infotainment system components, other network switches or routers, etc., in the vehicle and, in some embodiments, the number of different applications implemented on the devices in the vehicle. Although the network device 102 is generally described herein in the context of an automotive Ethernet network used in a vehicle, the network device is configured to operate in other suitable networks with a limited number of nodes, in other embodiments. As just an example, the network device 102 is configured to operate in an enterprise Ethernet network that includes a limited number of enterprise devices (e.g., a limited number of employee computers, laptops, etc.), in some embodiments.

In an embodiment, the network device 102 is a switch or a router configured to forward and/or route packets based on layer 3 and/or layer 4 information in headers of the packets. Layer-3 information includes address information such as source internet protocol (IP) address and destination IP address, for example. Layer-4 information includes source transmission control protocol (TCP)/user datagram protocol (UDP) port number, and destination TCP/UDP port number, for example. Routing packets based on layer 3 and layer 4 information allows the network device 102 to appropriately route packets between i) network devices in the network 100 that are identified by the layer 3 address information in the headers of the packets and ii) particular applications or services that are identified by the layer 4 port number information in the headers of the packets, in an embodiment.

The network device 102 includes a packet processor 104 coupled to a plurality of network interfaces 106 (e.g., ports, link aggregate groups (LAGs), tunnel interfaces, etc.) configured to couple to other devices in the network 100 over network links. The network interfaces 106 are coupled to ECUs 108 in the network 100, in the illustrated embodiment. The ECUs 108 include various types of electronic control units, such as electronic control units that communicate with various sensors, actuators, etc. to control operation of the vehicle. In various embodiments, the network device 102 includes any suitable number of network interfaces 106 that are coupled to any suitable number of other devices, such as ECUs, central units, infotainment system components, other network switches or routers, etc. operating in the network 100 in the vehicle. The packet processor 104 is configured to process packets received via ones of network interfaces 106, to determine network interfaces 106 via which the packets are to be forwarded, and to transmit the packets via the determined network interfaces 106, according to an embodiment.

The packet processor 104 includes a key generator 109 configured to generate one or more search keys 120 based on information within a header of a packet being processed by the packet processor 104. In an embodiment, the search key generator 109 is configured to generate respective search keys 120 among the one or more search keys 120 to includes layer-3 and/or layer 4 information obtained from the header of the packet. For example, the search key generator 109 is configured to generate a first search key 120 to include an IPV4/IPv6 source address in the header of the packet, a second search key 120 to include an IPV4/IPv6 source address in the header of the packet, a third search key 120 to include a TCP/UDP source port number in the header of the packet, and a fourth search key 120 to include a TCP/UDP destination port number in the header of the packet. In other embodiments, the search key generator 109 is configured to generate fewer search keys or a greater number of search keys.

The packet processor 104 is configured to provide the one or more search keys 120 generated by the search key generator 109 to a search engine 110. The search engine 110 is configured to identify one or more processing rules (sometimes referred to herein as simply “rules”) matched by the packet based on the one or more search keys 120 generated for the packet, and to determine an action 126 to be performed with respect to the packet based on the one or more processing rules matched by the packet. The actions 126 indicate via which port the network device should transmit the packet, to which virtual local area network (VLAN) the network device should route the packet, which priority the network device should assign to the packet, whether to drop the packet, whether to mirror the packet, etc. The search engine 110 is configured to provide an indication of the action 126 to the packet processor 104. The packet processor 104 is configured to further process and/or transmit the packet according to the action 126, in an embodiment.

The search engine 110 includes or is coupled to a multi-stage match memory 111 and an action memory 116. The multi-stage match memory 111 comprises multiple stages of TCAM memories, in an embodiment. The multi-stage match memory 111 comprises multiple stages of suitable memories different from TCAM memories, in another embodiment. For example, the multi-stage match memory 111 includes one or more stages of CAM memories, in some embodiments. The multi-stage match memory 111 includes a first-stage memory (e.g., first-stage TCAM) 112 and a second-stage memory (e.g., second stage TCAM) 114. The first-stage memory 112 is configured to map the search keys 120 to search key identifiers 122 that are shorter (e.g., include fewer numbers of bits) than the search keys 120. The second-stage memory 114 is configured to store search patterns corresponding to processing rules to map the search key identifiers 122 to an index of a processing rule 124 matched by the packet. The action memory 116 comprises a separate memory, such as a random access memory (RAM), that stores actions associated with the processing rules, in an embodiment. The search engine 110 is configured to access the action memory 116 based on the index of a processing rule 124 matched by the packet to identify the action 126 to be performed with respect to the packet, in an embodiment.

In various embodiments, because the network device 102 is configured to operate in the network 100 (e.g., an automotive Ethernet network) that includes a limited number of nodes and a limited number of applications executing on the nodes, although the network device 102 utilizes layer 3 and/or layer 4 packet header information to process packets, the number of unique layer 3 and/or layer 4 identifiers used to process packets by the network device 102 is limited and is significantly less than the number of identifiers that can be represented by numbers of bits included in the layer 3 and/or layer 4 fields in the headers of the packets. As just an example, in an embodiment, the number of unique IPV6/IPV4 addresses of devices in the network 100 is significantly less than the number of all possible IPv6/IPV4 addresses in the standard IPv6/IPv4 address space. Accordingly, the IPV6/IPV4 addresses used in the network can be uniquely represented by a number of bits that is significantly less than the standard number of IPv6/IPv4 address bits. Similarly, in an embodiment, the number of unique TCP/UDP port numbers used by devices in the network is significantly less than the number of all possible TCP/UDP port numbers in the standard TCP/UDP port number space. Accordingly, the TCP/UDP port numbers used by the devices in the network can be uniquely represented by a number of bits that is significantly less than the standard number of TCP/UDP port number bits.

In an embodiment, rules for processing packets by the network device are defined in the second-stage memory 114 using the shorter search key IDs 122 that uniquely represent all possible header field values used in the limited network. The first-stage memory 112 is used to map the search keys 120 to the shorter search key IDs 122, and the shorter search key IDs 122 are then matched to the rules stored in the second-stage memory 114 to identify a rule matched by the packet. Because the rules in multi-stage match memory 111 are defined in terms of the shorter search key IDs that uniquely represent all possible header field values used in the limited network, instead of being defined in terms of the longer header field values themselves, the multi-stage match memory 111 offers significant saving in terms of size, power consumption, cost, etc., of the match memory 111, without sacrificing any flexibility in uniquely defining the rules, as compared to systems in which the longer header field values are used for defining and matching the rules, in at least some embodiments.

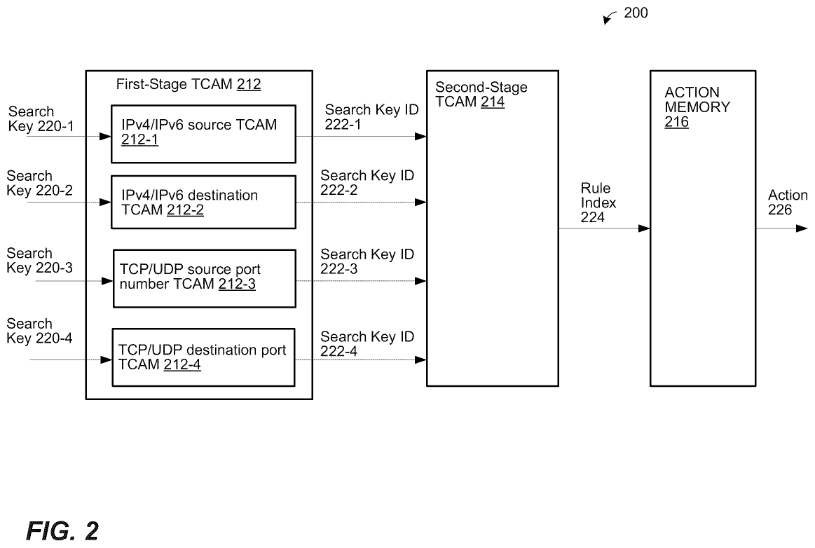

FIG. 2 is a block diagram of a search engine 200, according to an embodiment. The search engine 200 corresponds to the search engine 110 of the network device 102 of FIG. 1, in an embodiment, and for case of explanation, the search engine 200 is described with reference to FIG. 1. In other embodiments, however, the search engine 200 is used in another suitable network device different than the network device 102 of FIG. 1. Similarly, the search engine 110 of the network device 102 of FIG. 1 is different from the search engine 200, in some embodiments.

The search engine 200 includes a first-stage TCAM 212 and a second-stage TCAM 214. The first-stage TCAM 212 is configured to map search keys 220 generated based on header fields of a packet to search key identifiers 222 that are shorter than the corresponding search keys 220. The first-stage TCAM 212 stores unique IPV6/IPV4 addresses of devices in the network 100 and unique TCP/UDP port numbers used by the devices in the network 100. Because the number of unique IPv6/IPV4 addresses of devices in the network 100 is significantly less than the number of all possible IPv6/IPV4 addresses in the IPV6/IPV4 address space, the IPv6/IPV4 addresses used in the network 100 can be uniquely represented by a number of bits that is significantly less than the number of IPV6/IPV4 address bits. As just an example, whereas a standard IPv6 address comprises 128 bits, the different IPV6 addresses used in the network 100 can be uniquely represented with only 7 bits, in an embodiment. Similarly, whereas a standard TCP/UDP port number comprises 16 bits, the different TCP/UDP port numbers used in the network 100 can be represented with only 7 bits, in an embodiment. Thus, mapping search keys generated based on header fields to shorter search key IDs, and defining rules based on the shorter search key IDs, allows the network device 102 to support a certain number of rules with significantly fewer total TCAM bits as compared to systems that define the same number of rules using the search keys with mapping the search keys to search key IDs that are shorter than the search keys, in at least some embodiments.

In an embodiment, the first-stage TCAM 212 includes a plurality of entries storing search patterns that correspond to known patterns of header information. Different ones of the entries of the first-stage TCAM 212 store different known search patterns and are thus matched by different ones of the search keys 220. Accordingly, the search engine 200 is configured to map a search key 220 to a search key identifier 222 by searching entries of the first-stage TCAM 212 for an entry that matches the search key 220, and using an index of the entry that matches the search key 220 as the search key identifier 222. In an embodiment, the first-stage TCAM 212 is configured to provide mappings between multiple search keys 220 generated based on different packet header fields, such different layer 3 and/or layer 4 packet header fields, and respective search key identifiers 222 that are shorter than the corresponding search keys 220.

In an embodiment, the first-stage TCAM 212 includes a plurality of TCAMs, or independently accessible portions of a TCAM, that store known search patterns corresponding to the different packet header information, such as different packet header fields. For example, the first-stage TCAM 212 includes a first TCAM 212-1 having entries for matching IPv6/IPV4 source address information, a second TCAM 212-2 having entries for matching IPv6/IPV4 destination address information, a third TCAM 212-3 having entries for matching TCP/UDP source port number information, and a fourth TCAM 212-4 having entries for matching TCP/UDP destination port number information. The search engine 200 is configured to search respective ones of the TCAMs or TCAM portions in parallel to map respective ones of the plurality of search keys 220 to respective search key IDs 222 corresponding to matching entries in the first-stage TCAM 212.

In an embodiment, the search engine 200 is configured to receive a first search key 220-1 that includes IPv6/IPV4 source address obtained from a header of a packet, a second search key 220-2 that includes IPv6/IPV4 destination address obtained from the header of the packet, a third search key 220-3 that includes TCP/UDP source port number obtained from the header of the packet, and a fourth search key 220-4 that includes TCP/UDP destination port number obtained from the header of the packet. The search engine 200 is configured to search the first TCAM 212-1 based on the first search key 220-1 that includes the IPV6/IPV4 source address obtained from the header of the packet to find a matching entry that corresponds to a first search key ID 222-1 that is shorter than the first search key 220-1. The search engine 200 is configured to search the second TCAM 212-2 based on the second search key 220-2 that includes the IPv6/IPV4 destination address obtained from the header of the packet to find a matching entry that corresponds to a second search key ID 222-2 that is shorter than the second search key 220-2. The search engine 200 is configured to search the third TCAM 212-3 based on the third search key 220-3 that includes TCP/UDP source port number obtained from the header of the packet to find a matching entry that corresponds to a third search key ID 222-3 that is shorter than the third search key 220-3. The search engine 200 is configured to search the fourth TCAM 212-4 based on the fourth search key 220-4 that includes TCP/UDP destination port number obtained from the header of the packet to find a matching entry that corresponds to a fourth search key ID 222-4 that is shorter than the fourth search key 220-4.

The search engine 200 is configured to perform a second-stage search in the second-stage TCAM 214 based on the search key IDs 222 identified in the first-stage search, in an embodiment. The second-stage TCAM 214 includes a plurality of entries that store search patterns for matching rules based on different combinations of the search key IDs 222. In an embodiment, each entry in the second-stage TCAM 214 includes one or more of i) an IPV4/IPv6 source address identifier, ii) an IPV4/IPv6 destination address identifier, ii) a TCP/UDP source port number identifier, and iv) a TCP/UDP destination port number identifier. In other embodiments, the entries in the second-stage TCAM 214 include other suitable identifiers used for defining the rules. Each identifier stored in the second-stage TCAM 214 is shorter (e.g., includes fewer bits) as compared to the corresponding field in the header of the packet. Because each identifier in the second-stage TCAM 214 has a fewer number of bits as compared to the number of bits in a corresponding search key 220 that includes information extracted from a header of a packet, the set of rules is programmed in the second-stage TCAM 214 using an overall reduced number of bits as compared to systems that define rules to include packet header information to be matched, in various embodiments.

The search engine 200 also includes or is coupled to an actions memory 216, in an embodiment. The actions memory 216 corresponds to the actions memory 116 of the search engine 110 of FIG. 1, in an embodiment. The search engine 200 is configured to access the action memory 216 based on the index of the processing rule 224 matched by the packet to identify the action 126 to be performed with respect to the packet, in an embodiment.

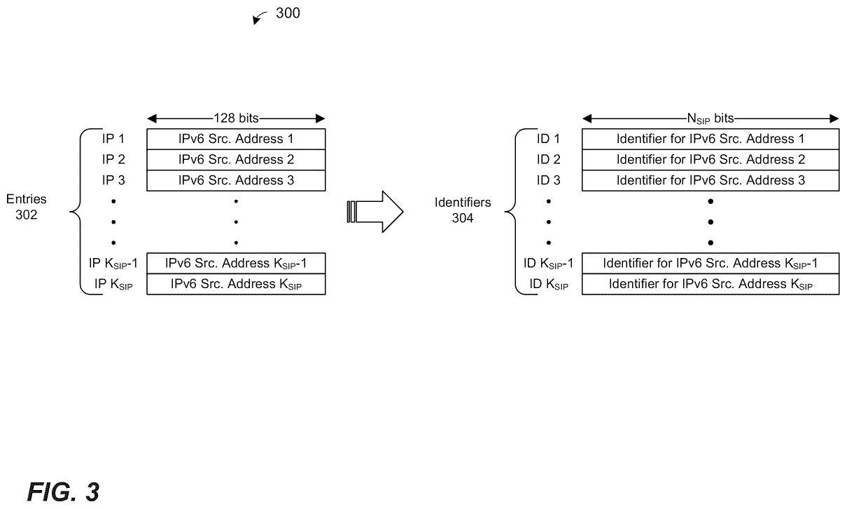

FIG. 3 is a diagram illustrating an example first-stage memory 300, according to an embodiment. In an embodiment, the first-stage memory 300 corresponds to the first-stage memory 212 of the search engine 200 of FIG. 2, and the first-stage memory 300 is described with reference to FIG. 2 for case of explanation. In other embodiments, however, the first-stage memory 300 is used with suitable devices different from the search engine 200 of FIG. 2. Similarly, the first-stage memory 212 of the search engine 200 of FIG. 2 is different from the first-stage memory 300, in some embodiments.

The first-stage memory 300 is configured to store unique IPv6 source addresses used in the network 100. In an embodiment, the first-stage memory 300 comprises a TCAM and the first-stage memory 300 is sometimes referred to herein as a “first-stage TCAM 300.” In other embodiments, the first-stage memory 300 comprises a suitable memory other than a TCAM. As just an example, the first-stage memory 300 comprises a CAM, in some embodiments. As just another example, the first-stage memory 300 comprises an exact match memory such as random access memory (RAM), e.g., static RAM (SRAM) or dynamic RAM (DRAM), in some embodiments.

The first-stage TCAM 300 includes a plurality of entries 302, respective entries 302 storing respective ones of the unique IPv6 source used within a set of K rules defined for processing packets in the network 100, in the illustrated embodiment. The first-stage TCAM 300 includes K_{SIP} entries corresponding to the number K_{SIP} of IPV6 source addresses used within the set of K rules defined for processing packets by the network device 102. In an embodiment, the unique IPv6 source addresses used in the network 100 includes a subset of IPV6 addresses that is significantly less than the total number of IPV6 addresses in the IPV6 address space. Further, the number K_{SIP} of IPV6 addresses that is used to define the set of rules for processing packets by the network device 102 is significantly less than the number K of rules in the set of rules defined for processing packets by the network device 102.

As illustrated in FIG. 3, respective ones of the unique IPv6 addresses stored in the first-stage TCAM 300 map search keys that match the unique IPv6 addresses to respective ones of search key identifiers in a set of identifiers 304. For example, respective ones of the unique IPv6 addresses stored in the first-stage TCAM 300 map search keys 220-1 that match the unique IPv6 addresses to respective ones of search key identifiers 222-1 in the set of identifiers 304. The set of identifiers 304 comprises identifiers that are shorter than the unique IPv6 addresses stored in the first-stage TCAM 300. For example, whereas an IPv6 addresses stored in the first-stage TCAM 300 comprises 128 bits, an identifier to which IPv6 addresses is mapped in the set of identifiers 304 comprises N_{SP} bits, where N_{SP} comprises fewer than 128 bits. In an embodiment, the identifiers in the set of identifiers 304 correspond to indices of the corresponding entries 302. In an embodiment, the number N_{SP} of bits in the identifiers in the set of identifiers 304 is determined by the number K_{SIP} of IPV6 addresses that is used to define the set of rules for processing packets by the network device 102. In particular, the relationship between the number N_{SIP} of bits in the identifiers in the set of identifiers 304 and the number K_{SIP} of IPV6 addresses that are used to define the set of rules for processing packets by the network device 102 is defined as 2^{N}^{_{SIP-1}}<K_{SIP} «2^{N}^{_{SIP}}.

It is noted that although FIG. 3 provided an example first-stage memory that stores IPv6 source addresses, and maps search keys that include IPv6 source addresses to identifiers that are shorter than the IPV6 source addresses, the concepts described with reference to FIG. 3 apply to first-stage memories that store header information other than IPv6 source addresses. For example, each of the IPV4/IPv6 source address TCAM 212-1, the IPv4/IPv6 destination address TCAM 212-2, the TCP/UDP source port number TCAM 212-3, and the TCP/UDP destination port number TCAM 212-4 is structured the same as or similar to the first-stage TCAM 300 to map search keys that include corresponding IPv4/IPv6 source/destination addresses and TCP/UDP source/destination port number obtained from headers of packets to identifiers that include fewer numbers of bits, in an embodiment. For example, the IPV4/IPv6 source address TCAM 212-1 is configured to remap the search key 220-1 that includes an IPV4/IPv6 source address extracted from a header of a packet to a search key identifier 222-1 that includes a number of bits N_{SIP} that is less than the number of bits in the search key 220-1, in an embodiment. The IPv4/IPv6 destination address TCAM 212-2 is configured to remap the search key 220-2 that includes an IPV4/IPv6 destination address extracted from the header of the packet to a search key identifier 222-2 that includes a number of bits N_{DIP} that is less than the number of bits in the search key 220-2, in an embodiment. The TCP/UDP source port number TCAM 212-3 is configured to remap the search key 220-3 that includes a TCP/UDP source port number extracted from the header of the packet to a search key identifier 222-3 that includes a number of bits N_{SP} that is less than the number of bits in the search key 220-3, in an embodiment. The TCP/UDP destination port number TCAM 212-4 is configured to remap the search key 220-4 that includes a TCP/UDP destination port number extracted from the header of the packet to a search key identifier 222-4 that includes a number of bits N_{DP} that is less than the number of bits in the search key 220-4, in an embodiment.

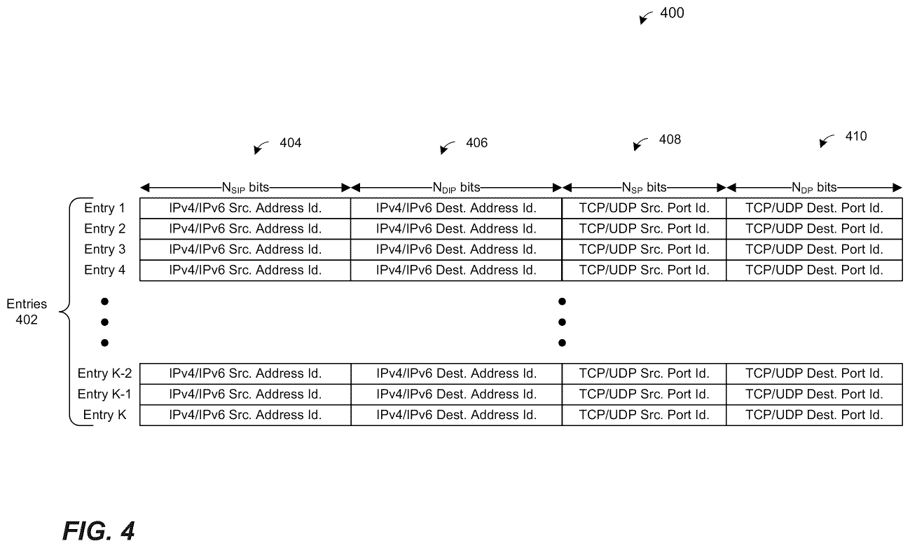

FIG. 4 is a diagram illustrating an example second-stage memory 400, according to an embodiment. In an embodiment, the second-stage memory 400 corresponds to the second-stage memory 214 of the search engine 200 of FIG. 2, and the second-stage memory 400 is described with reference to FIG. 2 for case of explanation. In other embodiments, however, the second-stage memory 400 is used with suitable devices different from the search engine 200 of FIG. 2. Similarly, the second-stage memory 214 of the search engine 200 of FIG. 2 is different from the second-stage memory 400, in some embodiments.

In an embodiment, the second-stage memory 400 comprises a TCAM and the second-stage memory 400 is sometimes referred to herein as a “second-stage TCAM 400.” In other embodiments, the second-stage memory 400 comprises a suitable memory other than a TCAM.

As just an example, the second-stage memory 400 comprises a CAM, in some embodiments. As just another example, the second-stage memory 400 comprises an exact match memory such as random access memory (RAM), e.g., static RAM (SRAM) or dynamic RAM (DRAM), in some embodiments.33

The second-stage TCAM 400 is configured to store combinations of search key identifiers for matching processing rules in a set of rules defined for processing packets in the network device 102, in an embodiment. The set of rules includes K rules, where K is an integer, in an embodiment. Accordingly, the second-stage TCAM 400 includes K entries 402, in the illustrated embodiment. Each entry 402 includes one or more of i) an IPV4/IPv6 source address identifier 404 comprising N_{SIP} bits, ii) an IPv4/IPv6 destination address identifier 406 comprising N_{DIP} bits, iii) a TCP/UDP source port number identifier 408 comprising N_{SP} bits, and iv) a TCP/UDP destination port number identifier 410 comprising N_{DP} bits. Because the number of bits of each identifier in the second-stage TCAM 400 has a fewer number of bits as compared to the number of bits in a corresponding search key that includes corresponding information extracted from a header of a packet, the set of rules is defined in the TCAM using an overall reduced number of bits as compared to systems that define rules to include packet header information to be matched, in various embodiments.

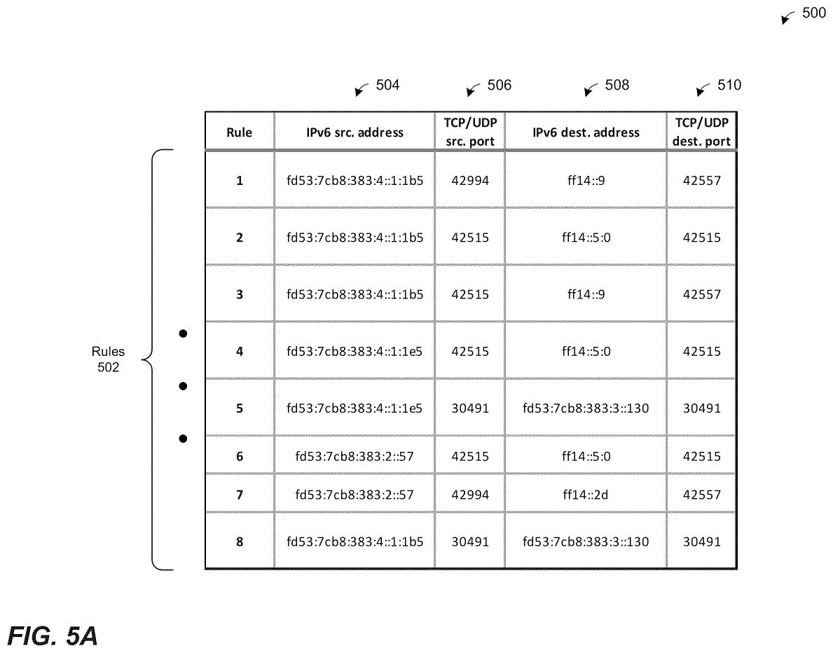

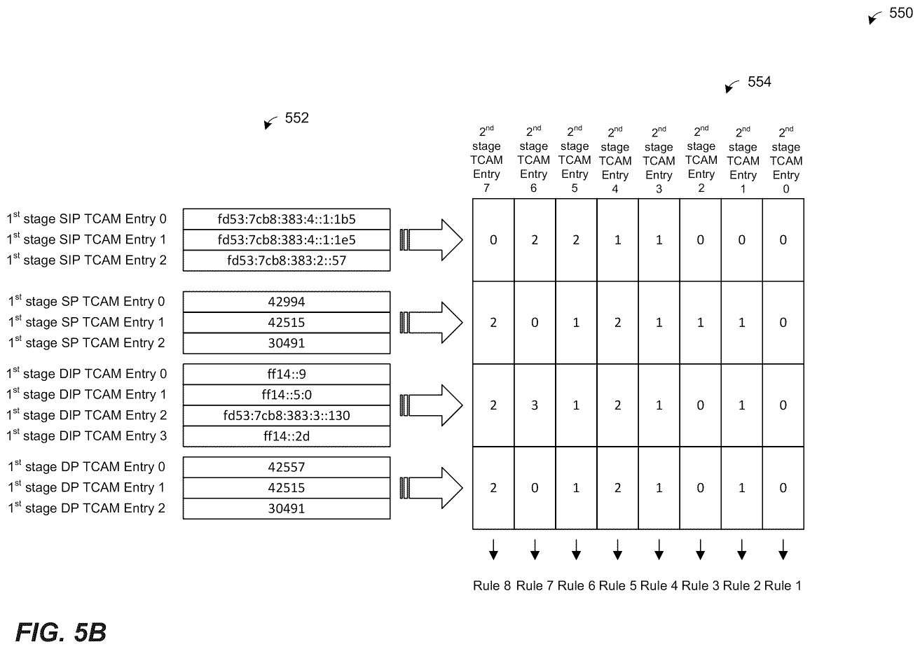

FIGS. 5A-B are diagrams illustrating an example set of rules and an example two-stage TCAM configured to implement precise matching to determine matching rules, according to an embodiment. In particular, FIG. 5A illustrates a set of rules 500 for processing packets by the network device 102. For case of explanation, the set of rules 500 includes eight rules, in the illustrated embodiment. The set of rules 500 generally includes a greater number of rules, such as thousands of rules, in some embodiments. As just an example, the set of rules 500 includes 4096 rules, in an embodiment. As can be seen in FIG. 5A, each rule in the set of rules 500 includes i) an IPV6 source address 504, ii) an IPV6 destination address 506, iii) a TCP/UDP source port 508, and iv) a TCP/UDP destination port 510. A packet that includes header fields having a combination of values of a particular rule 502 in the set of rules 500 is determined to match the particular rule 502, in an embodiment.

Referring now to FIG. 5B, the set of rules 500 is programmed into a two-stage search memory 550 including i) a first-stage memory 552 configured to re-map a search key that includes information from a header field of a packet to a search key identifier that is shorter than the search key and ii) a second-stage memory 554 that stores combinations of identifiers to be matched by the search key identifiers re-mapped by the first-stage memory 552. In the embodiments of FIGS. 5A-B, each rule 502 includes a unique value for each field in the rule 502. Thus, in the embodiments of FIGS. 5B, the two-stage search memory 550 is configured to provide precise matching that precisely match the identifiers mapped from the corresponding unique values of the header fields in the search key.

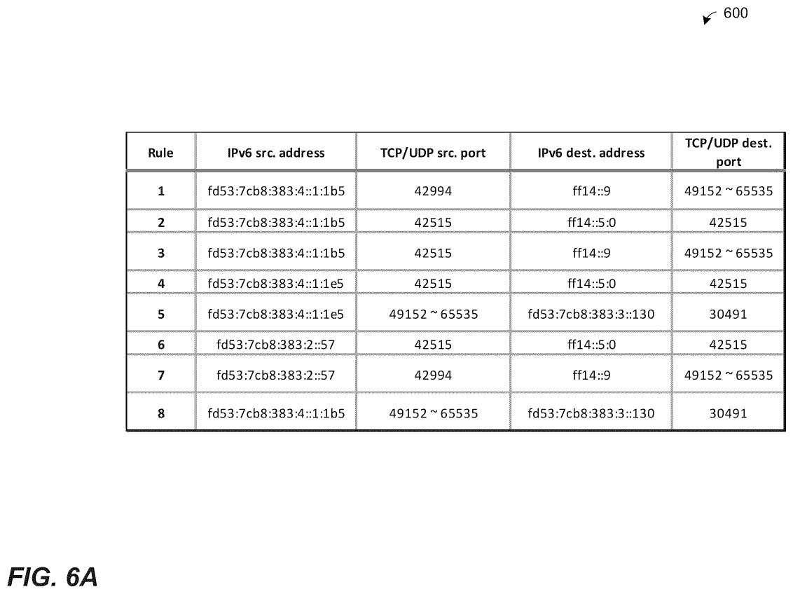

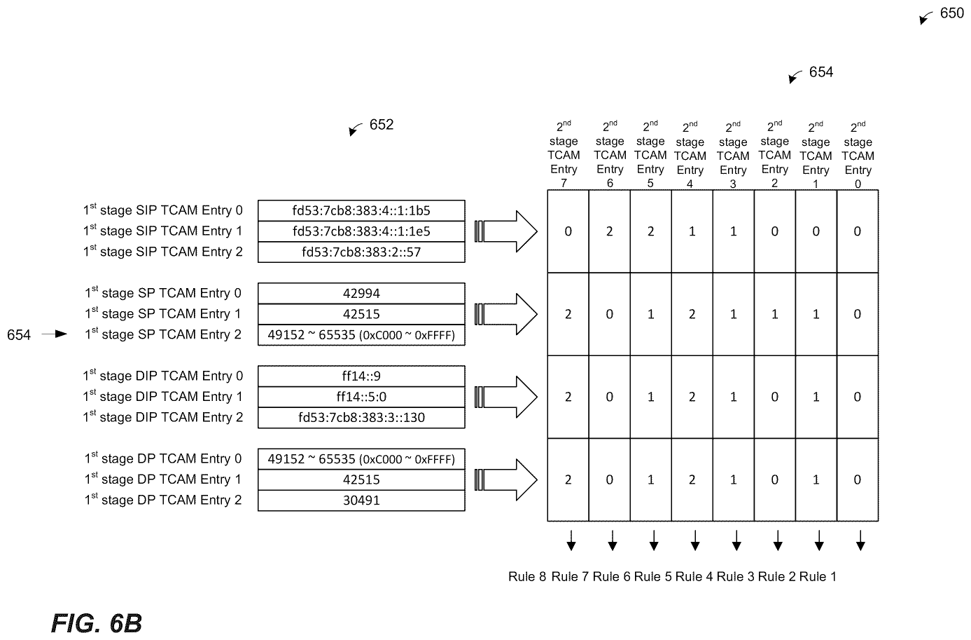

FIGS. 6A-B are diagrams illustrating, respectively, an example set of rules 600 and an example two-stage search memory 650 configured to implement binary maskable range matching with precise matching to determine matching rules, according to an embodiment. Referring to FIG. 6A, the set of rules 600 is generally the same as the set of rules 500 of FIG. 5A, except that the set of rules 600 includes a range of TCP/UDP source and destination port numbers included in some of the defined rules. Accordingly, as illustrated in FIG. 6B, a first-stage memory 652 of the two-stage search memory 650 includes masking in the corresponding TCP/UDP source and destination port number fields. For example, the first-stage memory 652 includes an entry 654 that includes a mask configured such that the entry 654 is matched by any value within a given range of port numbers (TCP/UDP port numbers within the range 49152-65535, in the illustrated embodiment) to a same search key identifier (search key identifier 2, in the illustrated embodiment). As a result, multiple search keys that include TCP/UDP source and destination port numbers within the defined ranges map to a same search key identifier, in the illustrated embodiment.

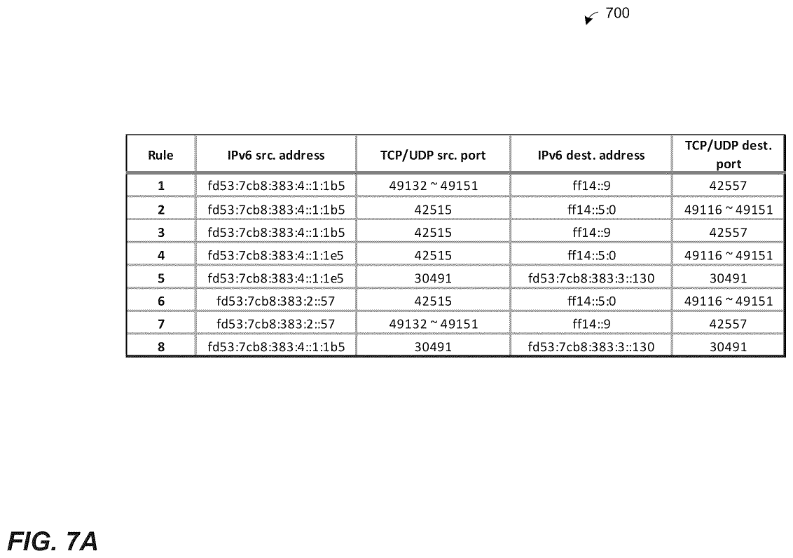

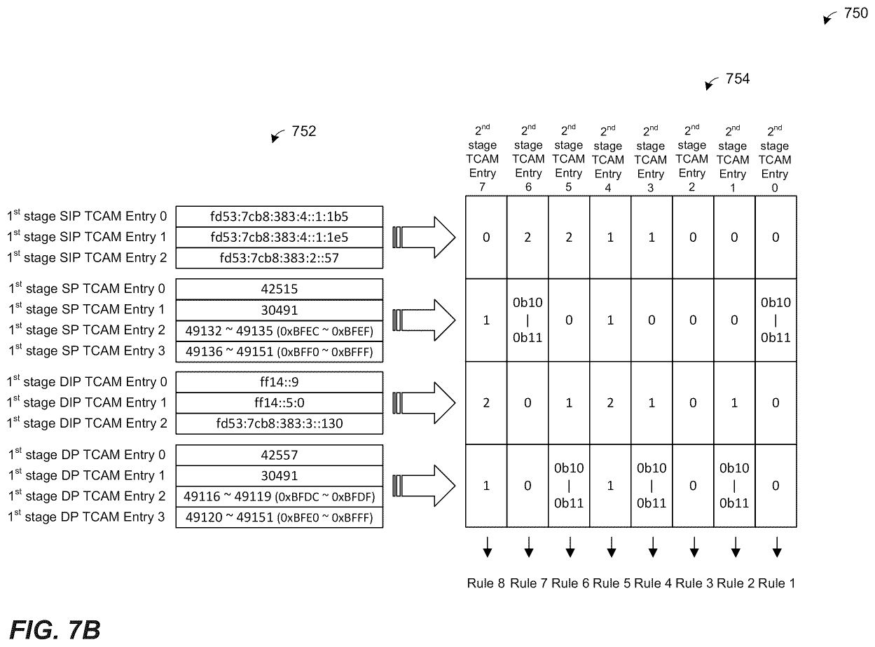

FIGS. 7A-B are diagrams illustrating, respectively, an example set of rules 700 and an example two-stage search memory 750 configured to implement non-binary maskable range matching with precise matching to determine matching rules, according to an embodiment. Referring to FIG. 7A, the set of rules 700 is generally the same as the set of rules 600 of FIG. 6A, except that the set of rules 700 includes different non-overlapping ranges of TCP/UDP source ports and TCP/UDP destination port numbers included in some of the defined rules. Accordingly, as illustrated in FIG. 7B, a first-stage memory 752 of the two-stage search memory 750 includes non-binary masking in multiple entries to store the corresponding TCP/UDP source and destination port number fields. As a result, multiple search keys that include TCP/UDP source and destination port numbers within the defined ranges map to different search key identifiers, in the illustrated embodiment. Accordingly, the second-stage memory 752 includes binary bit ranges in corresponding rule fields such that search keys in the overlapping port ranges will match the corresponding field in the second-stage memory 752.

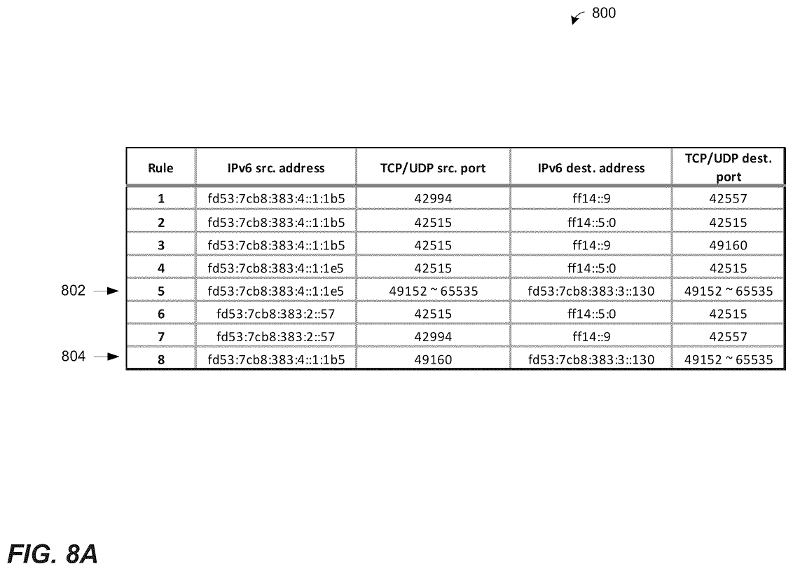

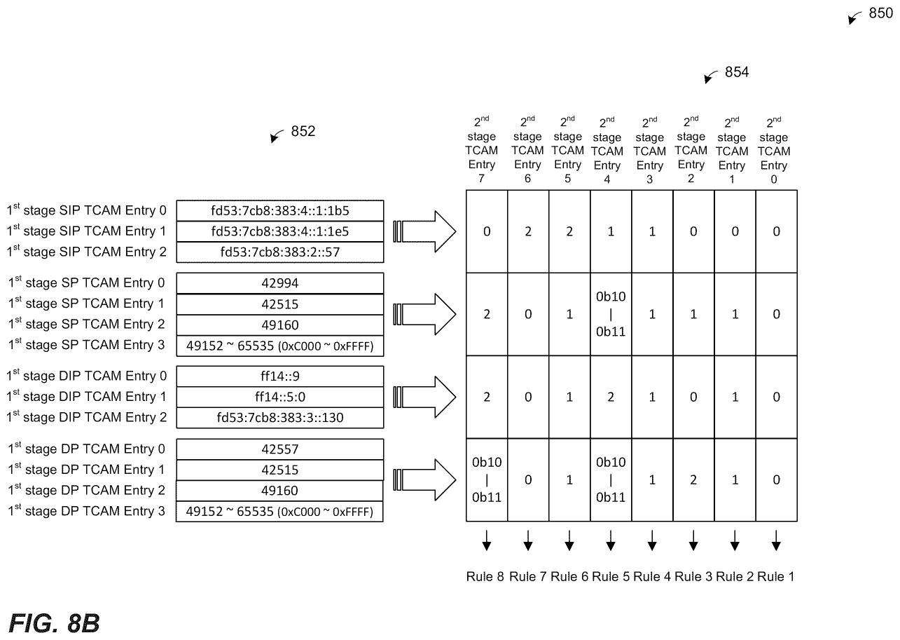

FIGS. 8A-B are diagrams illustrating, respectively, an example set of rules 800 and an example two-stage search memory 850 configured to implement binary maskable range matching with precise matching to determine matching rules, according to an embodiment. Referring to FIG. 8A, the set of rules 800 is generally the same as the set of rules 600 of FIG. 6A, except that the set of rules 800 includes a first rule (e.g., rule 802) that includes a port number range and a second rule (e.g., rule 804) that includes a port number that is within the port number range. Accordingly, as illustrated in FIG. 8B, a first-stage memory 852 of the two-stage search memory 850 includes masking value and that maps any value within the port number range to a first search key identifier or a second entry that includes the port number that is within the port number range and that maps the port number that is within the port number range to a second search key identifier different from the first search key identifier. As a result, multiple search keys that include TCP/UDP source and destination port numbers within the defined ranges map to a same search key identifier, in the illustrated embodiment. Accordingly, the second-stage memory 752 includes binary bit ranges in corresponding rule fields such that search keys in the overlapping port ranges will match the corresponding field in the second-stage memory 752.

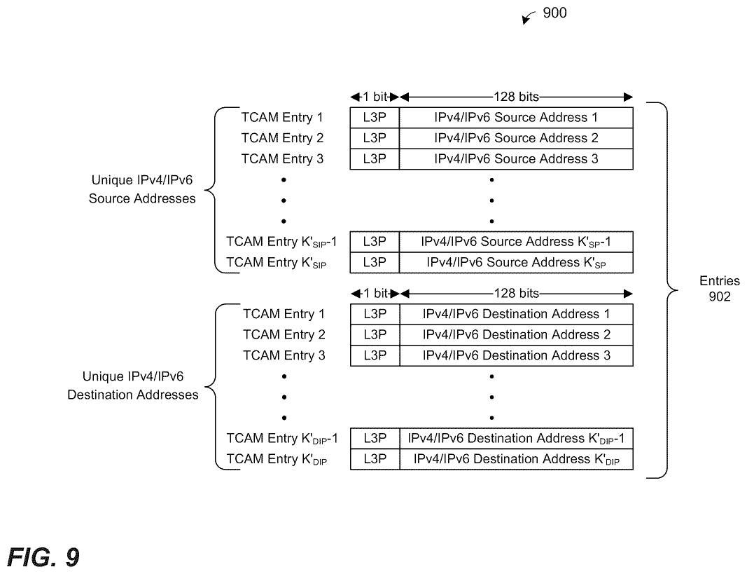

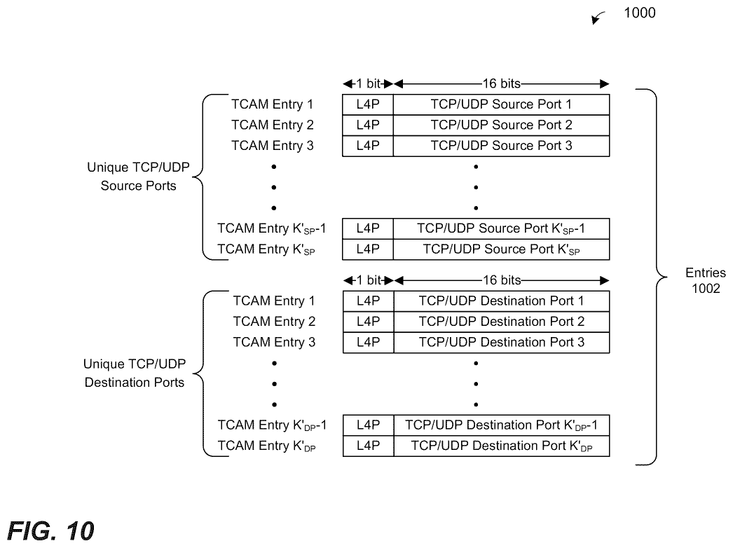

FIG. 9 is a block diagram of an example first-stage memory (e.g., TCAM) 900 that supports multiple layer 3 protocols, according to an embodiment. The first-stage memory 900 corresponds to the first-stage memory 112 of the search engine 110 of the network device 102 of FIG. 1, in an embodiment. The first-stage memory 900 corresponds to the first stage memory 212 of the search engine 200 of FIG. 2, in another embodiment. The first-stage memory 900 includes a plurality of entries 902. Each entry 902 includes either an IPV4 address or an IPV6 address, in the illustrated embodiment. Additionally, each entry 902 includes an additional bit (designated in FIG. 10 as “L3P” bit) to indicate whether the entry includes an IPV4 address or an IPV6 address, in the illustrated embodiment. The first-stage memory 900 thus supports matching of both search keys that include IPv4 header field information and search keys that include IPv6 header field information, in an embodiment.

FIG. 10 is a block diagram of an example first-stage memory (e.g., TCAM) 1000 that supports multiple layer 4 protocols, according to an embodiment. The first-stage memory 1000 corresponds to the first-stage memory 112 of the search engine 110 of the network device 102 of FIG. 1, in an embodiment. The first-stage memory 1000 corresponds to the first stage memory 212 of the search engine 200 of FIG. 2, in another embodiment. The first-stage memory 1000 includes a plurality of entries 1002. Each entry 1002 includes either a TCP port number or a UDP port number, in the illustrated embodiment. Additionally, each entry 1002 includes an additional bit (designated in FIG. 10 as “L4P” bit) to indicate whether the entry 1002 includes a TCP port number or a UDP port number, in the illustrated embodiment. The first-stage memory 1000 thus supports matching of both search keys that include TCP port header field information and search keys that include UDP header field information, in an embodiment.

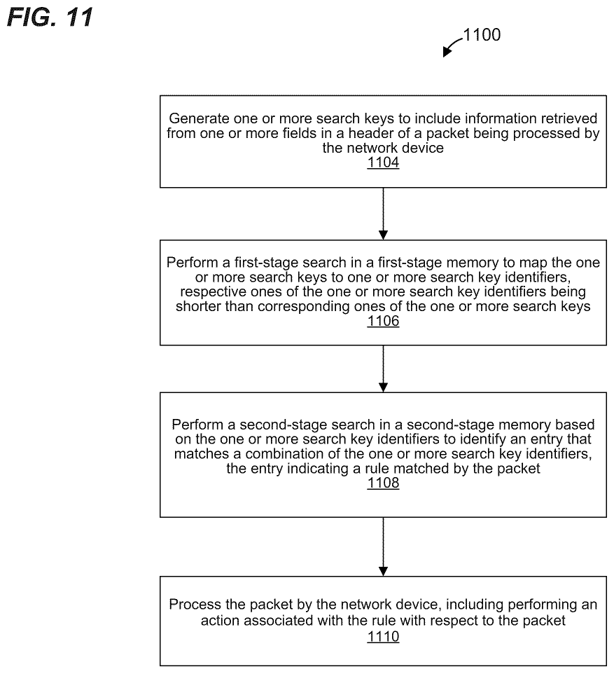

FIG. 11 is a flow diagram of an example method 1100 for processing packets by a network device operating in a network having a limited number of nodes, according to an embodiment. The method 1100 is implemented by the example network device 102, according to an embodiment. The method 1100 is implemented using the search engine 200 of FIG. 2, according to an embodiment. The method 1100 is described with reference to FIGS. 1 and 2 merely for illustrative purposes. In other embodiments, the method 1100 is implemented by another suitable network device different than the network device 102 of FIG. 1 and/or using a search engine different from the search engine 200 of FIG. 2.

At a block 1104, one or more search keys are generated to include information retrieved from one or more fields in a header of a packet being processed by the network device. For example, the one or more search keys include one or more of i) a first search key that includes an IPV4 or an IPV6 source address extracted from the header of the packet, ii) a second search key that includes an IPV4 or an IPV6 destination address extracted from the header of the packet, iii) a third search key that includes TCP or a UDP source port number extracted from the header of the packet, or iv) a fourth search key that includes a TCP or a UDP destination port number extracted from the header of the packet. In other embodiments, the one or more search keys additionally or alternatively include other information extracted from the header of the packet.

At a block 1106, a first-stage search is performed in a first-stage memory to map the one or more search keys to one or more search key identifiers. In an embodiment, respective ones of the one or more search key identifiers are shorter than corresponding ones of the one or more search keys. Generally, the numbers of bits in the one or more search key identifiers are determined by a number of nodes in the network, the number of applications executed on the nodes in the network, and the number of unique values of header fields used for defining processing rules for the network device, in an embodiment.

At a block 1108, a second-stage search is performed in a second-stage memory based on the one or more search key identifiers to identify an entry that matches a combination of the one or more search key identifiers, the entry indicating a rule matched by the packet. The second-stage memory includes a plurality of entries that define respective processing rules using the shorter search key identifiers identified in the first-stage search. Accordingly, because the rules in second-stage memory are defined in terms of the shorter search key identifiers that uniquely represent all possible header field values used in the limited network, instead of being defined in terms of the longer header field values themselves, the multi-stage search architecture offers significant saving in terms of size, power consumption, cost, etc., of the memory, without sacrificing any flexibility in uniquely defining the rules, as compared to systems in which the longer header field values are used for defining and matching the rules, in at least some embodiments.

At a block 1110, the packet is processed by the network device. Processing of the packet at block 1110 includes performing an action associated with the rule with respect to the packet. Performing the action includes transmitting the packet via a particular network interface (e.g., port) of the network device, routing the packet to a particular virtual local area network (VLAN), assigning a particular transmission priority to the packet, etc., in various embodiments.

Embodiment 1: A method for processing packets by a network device operating in a network having network nodes, the method comprising: generating, by the network device, one or more search keys to include information retrieved from one or more fields in a header of a packet being processed by the network device; performing, the network device, a first-stage search in a first-stage memory to map the one or more search keys to one or more search key identifiers, respective ones of the one or more search key identifiers being shorter than corresponding ones of the one or more search keys; performing, by the network device, a second-stage search in a second-stage memory based on a combination of the one or more search key identifiers to identify an entry, in the second-stage memory, that matches the combination of the one or more search key identifiers, the entry indicating a rule, among a set of rules defined for processing packets by the network device, matched by the packet; and performing, with respect to the packet, an action associated with the rule.

Embodiment 2: The method of embodiment 1, wherein performing the first-stage search in the first-stage memory includes performing the first-stage search based on a particular search key among the one or more search keys in a first-stage ternary content accessible memory (TCAM) that includes a plurality of entries storing only a subset of possible values of a header field corresponding to the particular search key, the subset of possible values including only values that are used by the nodes in the network.

Embodiment 3: The method of embodiment 2, wherein performing the first-stage search in the first-stage TCAM based on the particular search key includes searching the first-stage TCAM to find an entry that matches the particular search key, wherein an index of the entry that matches the particular search key corresponds to a search key identifier that maps to the particular search key.

Embodiment 4: The method of embodiment 2 or 3, wherein performing the first-stage search in the first-stage memory includes performing respective searches in respective ones of multiple first-stage TCAMs based on respective ones of the one or more search keys to find respective entries that match respective ones of the one or more search keys, wherein respective indexes of the entries that match the respective ones of the one or more search keys correspond to respective search key identifiers that map to the respective search keys.

Embodiment 5: The method of any of embodiments 1-4, wherein performing the second-stage search comprises performing the second-stage search in a second-stage ternary content accessible memory (TCAM) that includes a plurality of entries storing search patterns corresponding to different combinations of the one or more search key identifiers that are shorter than the corresponding ones of the one or more search keys.

Embodiment 6: The method of embodiment 5, wherein: the set of rules defined for processing packets by the network device includes one or more rules that include ranges of port numbers; and performing the first-stage search includes identifying an entry in the first-stage memory that includes a masked value that maps any value within a given range of port numbers to a same search key identifier.

Embodiment 7: The method of embodiment 5 or 6, wherein: the set of rules defined for processing packets by the network device includes a first rule that includes a port number range and a second rule that includes a port number that is within the port number range; performing the first-stage search includes identifying a first entry in the first-stage memory that includes a masked value and that maps any value within the port number range to a first search key identifier or a second entry that includes the port number that is within the port number range and that maps the port number that is within the port number range to a second search key identifier different from the first search key identifier; and performing the second-stage search includes identifying an entry in the second-stage memory that matches both the first search key identifier and the second search key identifier.

Embodiment 8: The method of any of embodiments 1-7, wherein performing the first-stage search in the first memory includes performing the first-stage search to map one or both of i) layer 3 information included in the one or more search keys to one or more search key identifiers, the layer 3 information extracted from a layer 3 header of the packet and ii) layer 4 information included in the one or more search keys to one or more search key identifiers, the layer 3 information extracted from a layer 4 header of the packet.

Embodiment 9: The method of any of embodiments 1-8, wherein performing the first-stage search in the first memory includes performing the first-stage search to map one or more of i) a first search key that includes an internet protocol version four (IPv4) or an internet protocol version six (IPv6) source address extracted from the header of the packet to a first search key identifier, ii) a second search key that includes an IPV4 or an IPV6 destination address extracted from the header of the packet to a second search key identifier, iii) a third search key that includes a transmission control protocol (TCP) or a user datagram protocol (UDP) source port number extracted from the header of the packet to a third search key identifier, or iv) a fourth search key to include a TCP or a UDP destination port number extracted from the header of the packet to a fourth search key identifier.

Embodiment 10: The method of any of embodiments 1-9, wherein: the network is an automotive Ethernet network in a vehicle; and performing the action associated with the rule with respect to the packet includes transmitting the packet to another device in the vehicle via the automotive Ethernet network.

Embodiment 11: A network device, comprising: a packet processor configured to process packets communicated over a network having network nodes, the packet processor including a key generator configured to generate one or more search keys based on one or more header fields in a header of a packet being processed by the network device; and a search engine configured to determine an action to be performed with respect to the packet based on the one or more search keys, the search engine configured to: perform a first-stage search in a first-stage memory to map the one or more search keys to one or more search key identifiers, respective ones of the one or more search key identifiers being shorter than corresponding ones of the one or more search keys; perform a second-stage search in a second-stage memory based on a combination of the one or more search key identifiers to identify an entry that matches the combination of the one or more search key identifiers, the entry indicating a rule matched by the packet; identify an action to be performed with respect to the packet based on the rule matched by the packet; and provide an indication of the action to the packet processor to perform the action with respect to the packet, based on the rule.

Embodiment 12: The network device of embodiment 11, wherein the first-stage memory comprises a first-stage ternary content accessible memory (TCAM) that includes a plurality of entries storing only a subset of possible values of a header field corresponding to a particular search key, the subset of possible values including only values that are used by the nodes in the network.

Embodiment 13: The network device of embodiment 12, wherein the search engine is configured to search the first-stage TCAM based on a particular search key to find an entry that matches the particular search key, wherein an index of the entry that matches the particular search key corresponds to a search key identifier that maps to the particular search key.

Embodiment 14: The network device of embodiment 12 or 13, wherein the first-stage TCAM includes multiple TCAMs that include respective entries storing respective subsets of possible values of respective header fields corresponding to respective search keys among the one or more search keys, the respective subsets of possible values including only values that are used by the nodes in the network.

Embodiment 15: The network device of any of embodiments 12-14, wherein the second-stage memory comprises a second-stage TCAM that includes a plurality of entries storing search patterns corresponding to different combinations of the one or more search key identifiers that are shorter than the corresponding ones of the one or more search keys.

Embodiment 16: The network device of embodiment 15, wherein: the set of rules defined for processing packets by the network device includes one or more rules that include ranges of port numbers; and the search engine is configured to, in the first-stage search, identify an entry in the first-stage memory that includes a masked value that maps any value within a given range of port numbers to a same search key identifier.

Embodiment 17: The network device of embodiment 15 or 16, wherein: the set of rules defined for processing packets by the network device includes a first rule that includes a port number range and a second rule that includes a port number that is within the port number range; and the search engine is configured to: in the first-stage search, identify a first entry in the first-stage memory that includes a masked value and that maps any value within the port number range to a first search key identifier or a second entry that includes the port number that is within the port number range and that maps the port number that is within the port number range to a second search key identifier different from the first search key identifier; and in the second-stage search, identify an entry in the second-stage memory that matches both the first search key identifier and the second search key identifier.

Embodiment 18: The network device of any of embodiments 11-17, wherein the packet processor is configured to perform the first-stage search to map one or both of i) layer 3 information included in the one or more search keys to one or more search key identifiers, the layer 3 information extracted from a layer 3 header of the packet and ii) layer 4 information included in the one or more search keys to one or more search key identifiers, the layer 3 information extracted from a layer 4 header of the packet.

Embodiment 19: The network device of any of embodiments 11-18, wherein the packet processor is configured to perform the first-stage search to map one or more of i) a first search key that includes an internet protocol version four (IPv4) or an internet protocol version six (IPv6) source address extracted from the header of the packet to a first search key identifier, ii) a second search key that includes an IPV4 or an IPV6 destination address extracted from the header of the packet to a second search key identifier, iii) a third search key that includes a transmission control protocol (TCP) or a user datagram protocol (UDP) source port number extracted from the header of the packet to a third search key identifier, or iv) a fourth search key that includes a TCP or a UDP destination port number extracted from the header of the packet to a fourth search key identifier.

Embodiment 20: The network device of any of embodiments 11-19, wherein: the network is an automotive Ethernet network in a vehicle; and the packet processor is configured to route the packet based on the action to transmit the packet to another device in the vehicle via the automotive Ethernet network.

At least some of the various blocks, operations, and techniques described above are suitably implemented utilizing dedicated hardware, such as one or more of discrete components, an integrated circuit, an application-specific integrated circuit (ASIC), a programmable logic device (PLD), a processor executing firmware instructions, a processor executing software instructions, or any combination thereof. When implemented utilizing a processor executing software or firmware instructions, the software or firmware instructions may be stored in any suitable computer readable memory such a read-only memory (ROM), a random-access memory (RAM), etc. The software or firmware instructions may include machine readable instructions that, when executed by one or more processors, cause the one or more processors to perform various acts.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A method for processing packets by a network device operating in a network having network nodes, the method comprising:
generating, by the network device, one or more search keys to include information retrieved from one or more fields in a header of a packet being processed by the network device;
performing, the network device, a first-stage search in a first-stage memory to map the one or more search keys to one or more search key identifiers, respective ones of the one or more search key identifiers being shorter than corresponding ones of the one or more search keys;
performing, by the network device, a second-stage search in a second-stage memory based on a combination of the one or more search key identifiers to identify an entry, in the second-stage memory, that matches the combination of the one or more search key identifiers, the entry indicating a rule, among a set of rules defined for processing packets by the network device, matched by the packet; and
performing, with respect to the packet, an action associated with the rule.

2. The method of claim 1, wherein performing the first-stage search in the first-stage memory includes performing the first-stage search based on a particular search key among the one or more search keys in a first-stage ternary content accessible memory (TCAM) that includes a plurality of entries storing only a subset of possible values of a header field corresponding to the particular search key, the subset of possible values including only values that are used by the nodes in the network.

3. The method of claim 2, wherein performing the first-stage search in the first-stage TCAM based on the particular search key includes searching the first-stage TCAM to find an entry that matches the particular search key, wherein an index of the entry that matches the particular search key corresponds to a search key identifier that maps to the particular search key.

4. The method of claim 2, wherein performing the first-stage search in the first-stage memory includes performing respective searches in respective ones of multiple first-stage TCAMs based on respective ones of the one or more search keys to find respective entries that match respective ones of the one or more search keys, wherein respective indexes of the entries that match the respective ones of the one or more search keys correspond to respective search key identifiers that map to the respective search keys.

5. The method of claim 1, wherein performing the second-stage search comprises performing the second-stage search in a second-stage ternary content accessible memory (TCAM) that includes a plurality of entries storing search patterns corresponding to different combinations of the one or more search key identifiers that are shorter than the corresponding ones of the one or more search keys.

6. The method of claim 5, wherein:
the set of rules defined for processing packets by the network device includes one or more rules that include ranges of port numbers; and
performing the first-stage search includes identifying an entry in the first-stage memory that includes a masked value that maps any value within a given range of port numbers to a same search key identifier.

7. The method of claim 5, wherein:
the set of rules defined for processing packets by the network device includes a first rule that includes a port number range and a second rule that includes a port number that is within the port number range;
performing the first-stage search includes identifying a first entry in the first-stage memory that includes a masked value and that maps any value within the port number range to a first search key identifier or a second entry that includes the port number that is within the port number range and that maps the port number that is within the port number range to a second search key identifier different from the first search key identifier; and
performing the second-stage search includes identifying an entry in the second-stage memory that matches both the first search key identifier and the second search key identifier.

8. The method of claim 1, wherein performing the first-stage search in the first memory includes performing the first-stage search to map one or both of i) layer 3 information included in the one or more search keys to one or more search key identifiers, the layer 3 information extracted from a layer 3 header of the packet and ii) layer 4 information included in the one or more search keys to one or more search key identifiers, the layer 3 information extracted from a layer 4 header of the packet.

9. The method of claim 1, performing the first-stage search in the first memory includes performing the first-stage search to map one or more of i) a first search key that includes an internet protocol version four (IPv4) or an internet protocol version six (IPv6) source address extracted from the header of the packet to a first search key identifier, ii) a second search key that includes an IPV4 or an IPV6 destination address extracted from the header of the packet to a second search key identifier, iii) a third search key that includes a transmission control protocol (TCP) or a user datagram protocol (UDP) source port number extracted from the header of the packet to a third search key identifier, or iv) a fourth search key to include a TCP or a UDP destination port number extracted from the header of the packet to a fourth search key identifier.

10. The method of claim 1, wherein:
the network is an automotive Ethernet network in a vehicle; and
performing the action associated with the rule with respect to the packet includes transmitting the packet to another device in the vehicle via the automotive Ethernet network.

11. A network device, comprising:
a packet processor configured to process packets communicated over a network having network nodes, the packet processor including a key generator configured to generate one or more search keys based on one or more header fields in a header of a packet being processed by the network device; and
a search engine configured to determine an action to be performed with respect to the packet based on the one or more search keys, the search engine configured to:
perform a first-stage search in a first-stage memory to map the one or more search keys to one or more search key identifiers, respective ones of the one or more search key identifiers being shorter than corresponding ones of the one or more search keys,
perform a second-stage search in a second-stage memory based on a combination of the one or more search key identifiers to identify an entry that matches the combination of the one or more search key identifiers, the entry indicating a rule matched by the packet,
identify an action to be performed with respect to the packet based on the rule matched by the packet, and
provide an indication of the action to the packet processor to perform the action with respect to the packet, based on the rule.

12. The network device of claim 11, wherein the first-stage memory comprises a first-stage ternary content accessible memory (TCAM) that includes a plurality of entries storing only a subset of possible values of a header field corresponding to a particular search key, the subset of possible values including only values that are used by the nodes in the network.

13. The network device of claim 12, wherein the search engine is configured to search the first-stage TCAM based on a particular search key to find an entry that matches the particular search key, wherein an index of the entry that matches the particular search key corresponds to a search key identifier that maps to the particular search key.

14. The network device of claim 12, wherein the first-stage TCAM includes multiple TCAMs that include respective entries storing respective subsets of possible values of respective header fields corresponding to respective search keys among the one or more search keys, the respective subsets of possible values including only values that are used by the nodes in the network.

15. The network device of claim 12, wherein the second-stage memory comprises a second-stage TCAM that includes a plurality of entries storing search patterns corresponding to different combinations of the one or more search key identifiers that are shorter than the corresponding ones of the one or more search keys.

16. The network device of claim 15, wherein:
the set of rules defined for processing packets by the network device includes one or more rules that include ranges of port numbers; and
the search engine is configured to, in the first-stage search, identify an entry in the first-stage memory that includes a masked value that maps any value within a given range of port numbers to a same search key identifier.

17. The network device of claim 15, wherein:
the set of rules defined for processing packets by the network device includes a first rule that includes a port number range and a second rule that includes a port number that is within the port number range; and
the search engine is configured to:
in the first-stage search, identify a first entry in the first-stage memory that includes a masked value and that maps any value within the port number range to a first search key identifier or a second entry that includes the port number that is within the port number range and that maps the port number that is within the port number range to a second search key identifier different from the first search key identifier, and
in the second-stage search, identify an entry in the second-stage memory that matches both the first search key identifier and the second search key identifier.

18. The network device of claim 11, wherein the packet processor is configured to perform the first-stage search to map one or both of i) layer 3 information included in the one or more search keys to one or more search key identifiers, the layer 3 information extracted from a layer 3 header of the packet and ii) layer 4 information included in the one or more search keys to one or more search key identifiers, the layer 3 information extracted from a layer 4 header of the packet.

19. The network device of claim 11, wherein the packet processor is configured to perform the first-stage search to map one or more of i) a first search key that includes an internet protocol version four (IPv4) or an internet protocol version six (IPv6) source address extracted from the header of the packet to a first search key identifier, ii) a second search key that includes an IPV4 or an IPV6 destination address extracted from the header of the packet to a second search key identifier, iii) a third search key that includes a transmission control protocol (TCP) or a user datagram protocol (UDP) source port number extracted from the header of the packet to a third search key identifier, or iv) a fourth search key that includes a TCP or a UDP destination port number extracted from the header of the packet to a fourth search key identifier.

20. The network device of claim 11, wherein:
the network is an automotive Ethernet network in a vehicle; and
the packet processor is configured to route the packet based on the action to transmit the packet to another device in the vehicle via the automotive Ethernet network.
